(19) United States
(12) Patent Application Publication
(10) Pub. No.: US 2021/0184546 A1
(43) Pub. Date: Jun. 17, 2021

(54) ELECTRIC ACTUATOR WITH WIRELESS DATA EXCHANGE MODULE

(71) Applicant: MINI MOTOR SOCIETA' PER AZIONI, BAGNOLO IN PIANO (RE) (IT)

(72) Inventor: Andrea FRANCESCHINI, CORREGGIO (RE) (IT)

(73) Assignee: MINI MOTOR SOCIETA' PER AZIONI, BAGNOLO IN PIANO (RE) (IT)

(21) Appl. No.: 16/771,021

(22) PCT Filed: Nov. 26, 2018
(86) PCT No.: PCT/IB2018/059301

§ 371 Date: Jun. 9, 2020

(30) Foreign Application Priority Data
Dec. 11, 2017 (IT) 102017000142358

(51) Int. Cl. H02K 11/35; H02K 11/00; H02K 11/215

(52) U.S. Cl. CPC H02K 11/35; H02J 50/10; H02K 11/215; H02K 11/0094

(57) ABSTRACT

An electric actuator (100) is herein described, for example a servomotor or a servo-geared motor, which comprises an electric motor (110), powered by a battery or via cable, and a wireless data exchange module (170) for remote control of the electric motor (110).

### TECHNICAL FIELD

The present invention relates to an actuator and, more particularly, to an electric actuator.

### BACKGROUND ART

As is known, an electric actuator is a device that is used, typically in the field of industrial automation, to vary and/or control the position of a moving member.

A standard electric actuator, also known as a servomotor, substantially comprises an electric motor and two data ports, respectively input and output data ports.

The actuator is wired via said two data ports, and put into communication with an electronic computer, which is configured to control operation of the motor according to the use it is intended for.

When the electric actuator is installed onto a fixed structure, the presence of this wiring does not generally represent a drawback, however it becomes such when the actuator is installed directly onto the moving member to be operated, as it may occur, for example, in the case where a slide is operated via a rack and pinion system.

In such cases, in fact, the connecting cables between the electric actuator and the computer should be long enough to reach the actuator in any position of the moving member, without hindering the movement of the latter and without interfering with other parts of the automated system.

Accordingly it may be sometimes rather difficult to comply with all these requirements, which still requires the adoption of measures, such as use of cable ducts or cable chains, making the automated system more complicated which results in increased costs and encumbrance.

### DISCLOSURE OF THE INVENTION

In light of the foregoing, it is an object of the present invention to overcome the aforementioned drawback of the prior art, within the scope of a simple, rational solution the cost of which is not excessively high.

The above and further objects are achieved owing to the characteristics of the invention as claimed in the independent claim 1. The dependent claims outline preferred and/or particularly advantageous aspects of the invention. Going into detail, according to one embodiment of the present invention an actuator is made available which comprises an electric motor and a wireless data exchange module.

For example, the wireless data exchange module may be associated with the actuator so as to be integral with the stator of the electric motor, thereby forming a single body with it and with the other engine components, which body though optionally removable, may be displaced and handled as a whole.

The wireless module can be rigidly fixed to the electric motor, in particular to the stator of the electric motor.

For example, the electric motor (in particular the stator) and the wireless data exchange module can both be rigidly fixed to a single rigid structure of the actuator, which structure acts as a common support such that these components are not movable one with respect to the other, thereby rigidly always maintaining the same relative position between them.

The wireless data exchange module can be a wireless module configured to connect to a computer network, such as a WLAN (Wireless Local Area Network), a WPAN (Wireless Personal Area Network), a WAN (Wide Area Network) or to a BWA (Broadband Wireless Access), through an appropriate communication standard, such as IEEE 802.11, IEEE 802.15, IEEE 802.16, IEEE802.20 or IEEE 802.22.

For example, the data exchange module can be configured to connect to a computer network via the ZigBee communication standard, M-Bus wireless, LoRa, Bluetooth or the like.

Owing to the wireless data exchange module, this actuator has the main advantage of being able to connect to an electronic control computer (e.g. PLC) without use of any wiring being needed.

In particular, the wireless data exchange module of the actuator can be connected only and exclusively with a corresponding wireless data exchange module (referred to as concentrator or coordinator), which is in turn connected (for example via cable) with the electronic control computer.

The actuator of the present invention may therefore be installed in any machine or automated system, both onto a fixed structure and onto a moving member, with great simplicity thus overcoming the drawbacks conventionally attributable to the presence of wiring.

According to one aspect of the present invention, the electric motor may be an alternating current motor, for example an asynchronous motor and preferably a three-phase asynchronous motor.

Alternatively, the electric motor may be a continuous current electric motor, for example a brushless motor.

This type of motor has the advantage of ensuring high efficiency and high controllability which makes it particularly suitable for use in the field of industrial automation.

Here, an aspect of the invention provides that the actuator may also comprise an electronic controller configured to operate and control the electric current transferred to the electric motor (from an electrical power supply source), so as to allow operation of the electric motor itself.

Also this electronic controller can be rigidly fixed to the electric motor, in particular to the stator of the electric motor.

For example, the electric motor (in particular the stator) and the wireless data exchange module can both be rigidly fixed to a single rigid structure of the actuator, which structure acts as a common support such that these components are not movable one with respect to the other thereby rigidly always maintaining the same relative position between them.

In particular, this electronic controller may be configured to operate and control switching of the electrical connections between the electrical power supply source and the electrical windings of the electric motor.

In fact, the connection between the stator windings of a brushless motor and the respective electrical power supply source must be repeatedly switched, in order that the direction of the current and hence the rotation of the induced magnetic field are cyclically reversed.

By providing the electric actuator with the aforementioned electronic controller it is therefore advantageously possible to make this type of motor also work, without the electric actuator having to be wired or otherwise connected to any further external control systems.

According to another aspect of the present invention, the electric actuator may also comprise an encoder capable of determining the position of a rotor of the electric motor with respect to a corresponding stator.

In this way, it is advantageously possible to know the position of the rotor in real time using it for handling the electric actuator.

In particular, according to one aspect of the invention it is provided that the encoder may be connected to the electronic controller, which may be configured to control the electric current being transferred to the electric motor based on the position of the rotor detected by the encoder.

This aspect is particularly useful especially in the case where the actuator comprises a brushless electric motor, wherein the reversal of the current flow on the electric stator windings shall take place when the rotor is located in established positions.

A further aspect of the invention provides that the actuator may also comprise a battery suitable for supplying the encoder.

This battery is useful to keep the rotor position monitored even when the actuator is not powered, for example when it is separated from the electrical power supply source.

According to some embodiments it is provided that said power supply source may be a fixed electricity distribution network and that the electric actuator may comprise an electrical outlet, through which the electric actuator can be wired to said fixed network directly or via an electrical panel of the device whereon it is installed.

Further embodiments provide, however, that the electric actuator may also comprise a main battery suitable for supplying the electric motor and preferably also the wireless data exchange module, thus acting itself as an electrical power supply source.

For example, the main battery may be associated with the actuator so as to be integral with the stator of the electric motor, thereby forming with it, the wireless data exchange module and the other motor components, a single body, which body, although possibly removable, may be displaced and handled as a whole.

The main battery can be rigidly attached to the electric motor, in particular to the stator of the electric motor.

For example, the electric motor (in particular the stator), the wireless data exchange module, the main battery and possibly the electronic controller, can all be rigidly fixed to a single rigid actuator structure, which structure acts as a common support such that these components are not movable one with respect to the other thereby rigidly always maintaining the same relative position between them.

Owing to the presence of the main battery, the electric actuator then achieves the advantage of being able to operate without being physically connected to any electrical panel and/or any fixed power supply network, thus making it unnecessary to use any type of connection cable to these external devices which, otherwise, might restrict the freedom of movement or limit installation possibilities thereof.

According to one aspect of the invention, the main battery may be rechargeable.

In this way, the electric actuator may have a long lifespan without need be of having to replace the main battery, but simply by subjecting the same to periodic recharge times.

Here, it is preferable that the electric actuator also comprises an electric power receiver connected to the main battery and adapted to connect wirelessly with a corresponding electric power transmitter, in order that a wireless charging system for the main battery is obtained.

Also the electric power receiver can be rigidly fixed to the electric motor, in particular to the stator of the electric motor.

For example, the electric motor (in particular the stator), the wireless data exchange module, the main battery and possibly the electronic controller, can all be rigidly fixed to a single rigid actuator structure, which structure acts as a common support such that these components are not movable one with respect to the other thereby rigidly always maintaining the same relative position between them.

Owing to this solution, the main battery may be effectively recharged without having to remove it from the electric actuator and without having to physically wire the electric actuator to any electrical power supply source.

This allows the electric actuator, and therefore the relative electric motor, to be able to move along with the application without any cable being needed, while the recharge point of the battery can be fixed, with the battery recharge occurring during the repeated passing of the electric actuator at said recharge point.

For example, it is simply possible to provide for the electric actuator being periodically brought in proximity to the electric power transmitter (or vice versa), where the main battery can be charged simply and wirelessly.

According to one aspect of the invention, the wireless charging system provided between the receiver and the power transmitter may be of the inductive type or, more preferably, of the capacitive type.

These wireless electric power transmission systems are indeed rather reliable and efficient. In particular, the capacitive system enables to transmit even very high powers with reduced losses being involved and with high levels of safety.

### BRIEF DESCRIPTION OF THE DRAWINGS

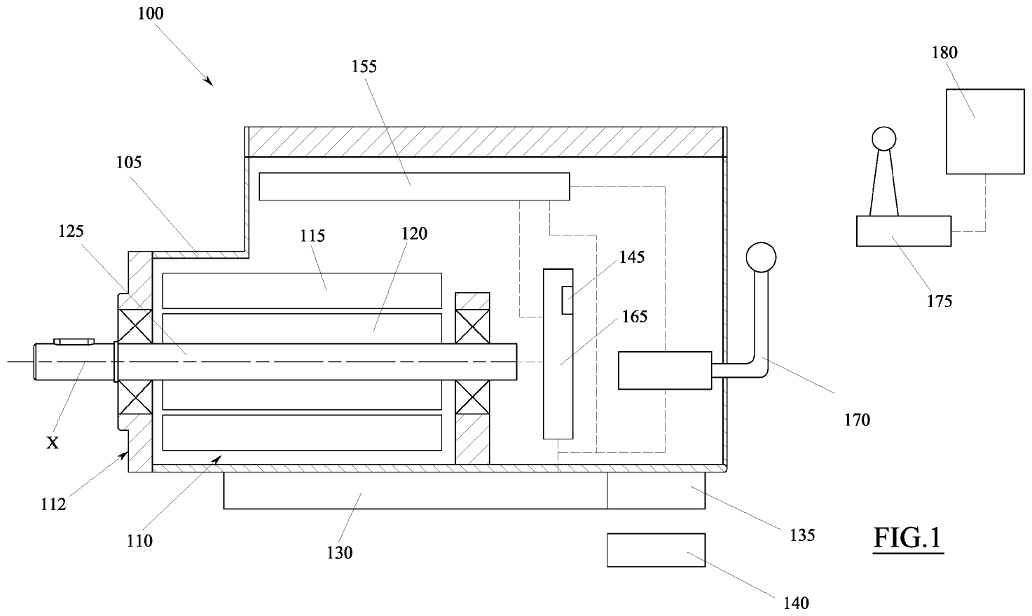

Further characteristics and advantages of the invention will become apparent from the reading of the following description given by way of non-limiting example, with the aid of FIG. 1 illustrated in the attached table, which schematically shows a longitudinal section of an electric actuator according to one embodiment of the present invention.

### DETAILED DESCRIPTION

The electric actuator 100 illustrated in the aforementioned FIGURE, also known as servomotor, may be used in any field of industrial automation, generally for modifying and/or controlling the position of a moving member, of a machine or a plant for example, relative to a fixed structure.

The electric actuator 100 generally comprises an outer casing 105, which contains an electric motor 110.

The outer casing 105 may comprise a fixing flange 112, through which the electric actuator 100 can be installed on an automated machine or apparatus.

The automated machine or apparatus may comprise, for example, a support structure and at least one movable member, which is connected to the support structure so as to be movable relative thereto.

The electric actuator 100 can be rigidly fixed, for example through the aforementioned fixing flange 112, to the support structure or the moving member, where it can be configured to actuate the movement of the moving member with respect to the supporting structure.

The fixing flange 112 may be flat and may exhibit several holes, for example through holes, into which fastening screws may be inserted.

In some embodiments, the electric motor 110 may be an electric motor in alternated current, for example a three-phase asynchronous motor, while in other embodiments, it may be a permanent magnets synchronous motor, for example a brushless motor.

The electric motor 110 comprises a stator 115 having a substantially annular shape, internally of which a rotor 120 is housed which is rotatably supported inside the outer casing 105, so as to be able to rotate relative to the stator 115 according to a predetermined axis of rotation X.

A shaft 125 may be integrally associated with the rotor 120, which shaft has an axis coinciding with the axis of rotation X and protruding outwardly of the casing 105, for example, through an opening formed within the fixing flange 112, so as to be mechanically connected, either directly or through suitable transmission members (e.g. gear reducers, screw-nut systems, and so on.) to a to be-moved moving member.

In some embodiments, these transmission members may be embedded within the electric actuator 100, for example accommodated within the outer casing 105, thereby forming a single body (e.g. a geared motor) that may be handled and moved as a whole.

In such cases, the shaft 125 of the electric motor 110 may remain confined within the casing 105, wherefrom a terminal will instead protrude, for example a rotating shaft or any other moving member located at the end of the kinematic chain defined by the transmission members.

Also in this case, the casing 105 may comprise a fixing flange, similar to the one outlined above, which is provided with an opening wherefrom the terminal can protrude outwardly.

In some embodiments, the electric actuator 100 may comprise an electrical outlet, through which it may be wired to an external electrical source suitable for supplying the electric motor 100, for example to the electrical panel of the apparatus whereon the electric actuator 100 is installed.

In the embodiment illustrated herein, the electric actuator 100 comprises instead a main battery 130, which may be obtained in the form of a single battery or a battery pack and which is suitable for supplying the electric motor 110.

The main battery 130 may be embedded within the electric actuator 100, thereby forming a single body that may be handled and moved as a whole.

For example, the main battery 130 may be rigidly fixed inside or, more preferably, outside the casing 105, in order to be solidly constrained with the stator 115 of the electric motor 110.

The main battery 130 may be of the rechargeable type, so as to be periodically recharged thus allowing a greater operating autonomy to the electric actuator 100.

In particular, the main battery 130 may be connected to a special electrical power receiver 135, which is adapted to implement a wireless connection with a corresponding external electric power transmitter 140, thereby forming a wireless charging system of the main battery 130 therewith.

In other words, the transmitter 140, which may be powered by a domestic or industrial electrical network, is able to wirelessly transmit electrical power to the receiver 135, which in turn transfers this electrical power to the main battery 130 and recharges it.

In particular, the electrical connection through which the electrical power transfer is obtained between the transmitter 140 and the receiver 135 may be of the inductive type or, more preferably, of the capacitive type.

Owing to this solution, the main battery 130 may be recharged even remotely, without having to remove it from the electric actuator 100 and without having to physically wire the electric actuator 100 to a power source.

The electric power receiver 135 may be rigidly fixed inside or, more preferably, outside the casing 105, in order to be rigidly connected to the stator 115 of the electric motor 110.

In the case where the electric motor 110 is of the brushless type, permanent magnets may be installed on the rotor 120, whereas on the stator 115 electric windings may be positioned which electric windings, when traversed by electric current, are capable of generating a magnetic field.

The electric windings of the stator 115 are therefore connected to the electrical power supply source, for example to the main battery 130, by means of suitable electrical connections.

In order for the rotor 120 of the brushless motor to be placed in rotation, it is necessary to repeatedly switch the connection between the windings of the stator 115 and the electrical power supply source, so as to cyclically reverse the direction of the electric current that runs through the windings and thus the rotation of the magnetic field induced by the former.

For this reason, the electrical connections between the windings of the stator 115 and the electrical power supply source may comprise diverter switches, for example transistors, which are connected and controlled by an electronic controller 155, for example by a microcontroller installed on a special card.

In some embodiments, the electronic controller 155 may be embedded within the electric actuator 100, thereby forming a single body that may be handled and moved as a whole.

For example, the electronic controller 155 may be rigidly fixed inside or outside the casing 105, in order to be solidly constrained with the stator 115 of the electric motor 110.

The electronic controller 155 may be connected in such a way as to be powered by the same electrical power supply source of the electric motor 110, for example by the main battery 130.

Together with the electronic controller 155, the electric actuator 100 may also comprise a heat sink (not shown), for example a block of thermally conductive material, exposed to the external environment and in a heat exchange relationship with the electronic controller 155, which is designed to improve the heat dissipation generated by the electronic controller 155 itself. This heat sink, which may be so shaped as to exhibit a plurality of lamellae suitable for increasing the heat exchange surface with the surrounding environment, may be rigidly fixed to the exterior of the casing 105, for example on a side of the casing 105 where it is adjacent to the electronic controller 155.

In order to correctly switch the connection between the main battery 130 and the windings of the stator 115, the electronic controller 155 may need to know the position of the rotor 120 relative to the stator 115, in order to determine the orientation to be impressed on the magnetic field.

For this reason, the electric actuator 100 may also comprise an encoder 165, for example an absolute magnetic encoder SSI, which is adapted to monitor the position of the rotor 120 relative to the stator 115 and is connected to the electronic controller 155.

The encoder 165 may also be embedded within the electric actuator 100, thereby forming a single body that may be handled and moved as a whole.

For example, the encoder 165 may be rigidly fixed inside the casing 105, in order to be solidly constrained with the stator 115 of the electric motor 110. The encoder 165 may be powered by the same electrical power supply source of the electric motor 110, for example from the main battery 130, but it may also comprise a secondary battery 145, which is adapted to supply the encoder 165 in the case where the electrical power supply source does not provide the requested power supply, for example if the main battery 130 is discharged.

In this way, the encoder 165 may continue to monitor the position of the rotor even during any rotations which may occur, for example which are due to external factors, with the electric actuator 100 being switched off, so that, upon following restart, the electronic controller 155 already knows the exact position of the rotor 120.

The electric actuator 100 lastly comprises a wireless data exchange module 170, which is connected to the electronic controller 155 and is adapted to provide a wireless communication channel with a corresponding wireless data exchange module 175 of an external electronic computer 180.

In particular, the wireless data exchange modules 170 and 175 can establish a communication network, for example a Wireless Local Area Network (WLAN), a Wireless Personal Area Network (WPAN), a Wide Area Network (WAN), or a BWA (Broadband Wireless Access), exchanging data through an appropriate communication standard, such as IEEE 802.11, IEEE 802.15, IEEE 802.16, IEEE802.20 or IEEE 802.22.

For example, the data exchange module 170 can be configured to connect to a computer network via the ZigBee communication standard, M-Bus wireless, LoRa, Bluetooth or the like.

Preferably, such a communication network will in any case be exclusive, i.e. the wireless data exchange module 170 of the electric actuator 100 will be connected only and exclusively to the wireless data exchange module 175 of the electronic computer 180.

The wireless data exchange module 170 as well is embedded within the electric actuator 100, thereby forming a single body that may be handled and moved as a whole.

For example, the wireless data exchange module 170 may be rigidly fixed inside or outside the casing 105, in order to be solidly constrained with the stator 115 of the electric motor 110.

The wireless data exchange module 170 may be connected in such a way as to be powered by the same electrical power supply source of the electric motor 110, for example by the main battery 130.

The electronic computer 180 is any electronic device, also referred to as master, configured to control operation of the machine or of the automated system into which the electric actuator 100 is to be installed.

For example, the electronic computer 180 may be a PLC.

Between the electronic computer 180 and the wireless data exchange module 170 an electronic coordinating device (not shown) can be interposed, which is configured to control the wireless network.

The coordinating device is connected, on one side, to the electronic computer 180, and on the other side, to the wireless data exchange module 175.

One or both of these connections can be obtained via an Ethernet cable.

In some embodiments, the coordinating device can be directly embedded into the wireless data exchange module 175.

The coordinating device can be configured to simultaneously control a plurality of electric actuators 100.

The commissioning of the electric actuators 100 (for example the network setup and the association of the electric actuators) can be implemented by a customized web server on the gateway itself in order to accelerate the development thus avoiding to involve the electronic computer 180 in such a demanding task.

The electronic computer 180 is configured to establish, for example based on the functions that the electric actuator 100 must perform in the machine or in the automated system, one or more of the following parameters: the moment in which the motor 110 is activated, the moment in which the motor 110 is deactivated, the direction of rotation of the rotor 120 relative to the stator 115, the rotation speed at which the rotor 120 must rotate, the absolute or relative position (for example expressed as an angle relative to a predetermined reference position, a number of revolutions or the like) that the rotor 120 must perform relative to the stator 115 and the torque to be delivered by the rotor 120 of the electric motor 110.

Through the wireless data exchange modules 170 and 175, the electronic computer 180 is further configured to transmit the above parameters to the electronic controller 155 of the actuator 100, which is in turn configured to control the electric motor 100 to operate according to the parameters received.

In the same manner, the electronic computer 180 can also be configured to manage the zeroing of the reference position, i.e. to set the relative reference position between the rotor 120 and the stator 115 of the electric motor 100.

For example, when the rotor 120 is in a given position relative to stator 115, the electronic computer 180 can set that position as a reference position.

To perform these functions or to control the operation of the electric motor 110, the electronic computer 180 can be further configured to receive from the actuator 100, through the wireless data exchange modules 170 and 175, the measured values of one or more of the following parameters: instantaneous rotor speed 120, absolute or relative instantaneous position of the rotor 120 relative to the stator 115, current absorbed by the electric motor 110, supply voltage of the electric motor 110, state of the motor and relative alarms, operating mode.

Owing to the wireless data exchange module 170 embedded within the electric actuator 100, any digital communication being needed between the electronic controller 155 and the electronic computer 180, intended for the exchange of instructions and/or information, may advantageously take place wirelessly, i.e. without the need for any physical wiring between the aforementioned components.

It goes without saying that, the one skilled in the art will be able to make multiple technical/applicative changes to the electric actuator 100 described above, all without departing from the scope of the invention which is defined by the appended claims.

1. An electric actuator (100) comprising an electric motor (110) and a wireless data exchange module (170).

2. The electric actuator (100) according to claim 1, wherein the electric motor is a brushless motor or an asynchronous motor.

3. The electric actuator (100) according to claim 1 further comprising an electronic controller (155) configured to operate and control the electric current transferred to the electric motor (110), so as to enable operation of the electric motor (110) itself.

4. The electric actuator (100) according to claim 1, further comprising an encoder (165) adapted to determine the position of a rotor (120) of the electric motor (110) relative to a corresponding stator (115).

5. The electric actuator (100) according to claim 4, wherein said encoder (165) is connected to the electronic controller (155), which is configured to control the electric current transferred to the electric motor (110) based on the rotor position (120) detected by the encoder (165).

6. The electric actuator (100) according to claim 4, further comprising a battery (145) suitable for supplying the encoder (165).

7. The electric actuator (100) according to claim 1, further comprising at least one main battery (130) suitable for supplying the electric motor (110).

8. The electric actuator (100) according to claim 7, wherein the main battery (130) is rechargeable.

9. The electric actuator (100) according to claim 8, further comprising an electric power receiver (135) connected to the main battery (130) and capable of connecting wirelessly with a corresponding electric power transmitter (140) thereby obtaining a wireless charging system of the main battery (130).

10. The electric actuator (100) according to claim 9, wherein said wireless charging system is an inductive system or a capacitive system.
